(19) United States
(12) Patent Application Publication
(10) Pub. No.: US 2002/0105187 A1
(43) Pub. Date: Aug. 8, 2002

(54) Riser connector

(76) Inventor: Brian Graham Taylor, Glasgow (GB)

Correspondence Address: DORSEY & WHITNEY LLP, Suite 400, 1660 International Drive, McLean, VA, 22102, US

(21) Appl. No.: 10/046,294

(22) Filed: Jan. 16, 2002

(30) Foreign Application Priority Data
Jan. 16, 2001 (GB) 0101084.2

(51) Int. Cl. F16L 25/00

(52) U.S. Cl. 285/333; 285/390

(57) ABSTRACT

A connector for connecting a first tubular to a second tubular; the connector comprising a first portion on the first tubular and a second portion on the second tubular, wherein the first and second portions each have axially extending portions which in the assembled connector are mutually parallel.

### BACKGROUND OF THE INVENTION

This invention relates to a riser connector and method for connecting pipes or risers used to transport fluids, particularly pipes or risers used in the offshore oil and gas industry to transport fluids from well-heads at the sea-bed to the surface.

Risers can comprise a string of pipes extending for thousands of feet. The connections between the individual pipes need to be secure for structural integrity of the riser, and need to avoid leaking fluids into the sea, and seepage of sea water into the pipe string. Moreover, risers typically need the capacity to bend somewhat to cope with the underwater currents. The bending forces applied to a particular pipe in the string are normally transferred to adjacent pipes via connections between the pipes so that the string as a whole absorbs the force. The connections between the pipes therefore need to be secure and capable of transferring such loads. Pipes used in such applications typically have a ‘box’ connector at one end and a ‘pin’ connector at an opposite end. A typical connection is shown in FIG. 1. The pin 3 of pipe 1 is threaded into the box 4 of pipe 2 to engage the threads 5, 6 provided on the pin 3 and box 4 respectively.

To connect the pipes 1, 2 in this way requires a significant amount of torque—typically 50,000 ft/lb. on a 10¾″ riser connector. The pin 3 and box 4 are typically gripped in the pingrip portion 7 and the box reaction grip portion 8 respectively as shown in FIG. 2.

The requirement to transfer forces across the pipe connections means that the threads in the box and pin need to be very close in tolerance, in order to ensure that the riser bends smoothly along its length rather than at the connections between pipes.

### SUMMARY OF THE INVENTION

According to a first aspect of the invention there is provided a connector for connecting a first tubular to a second tubular; the connector comprising a first portion on the first tubular and a second portion on the second tubular, wherein the first and second portions each have axially extending portions which in the assembled connector are mutually parallel.

Typically the first and second portions have mutually engaging threaded portions. Typically the axially extending portions are unthreaded. Preferably the axially extending portions are load-bearing and allow the transfer of loads between the tubulars.

Preferably two axially extending portions are provided on each tubular. Preferably the first axially extending portion on each tubular is greater in length than the second axially extending portion on each tubular. Preferably the axially extending portions on each tubular are provided above and below the threaded portion. Preferably a spigot and a socket comprise the axially extending portions on each tubular. Preferably the spigot is provided between the tubular's threaded face and terminus. Preferably the spigot on the first tubular engages the socket on the second tubular. Preferably the spigot on the second tubular engages the socket on the second tubular.

Typically the first tubular comprises a pin connector. Typically the second tubular comprises a box connector. Preferably the socket of the first tubular and spigot on the second tubular are greater in the length than the socket of the second tubular and spigot of the first tubular.

Typically the axially extending portions are parallel to the axis of the tubulars, but this is not essential.

Preferably the first and second tubulars have a tapered profile. Preferably the tapered portions of the first and second tubulars are the threaded portions of the first and second tubulars and have co-operating tapers to facilitate mating of the two portions.

Typically at least one seal is provided. Most typically two seals are provided. A first seal typically prevents ingress of fluid (e.g. sea water) from outside the connection of the connector to the threaded and axially extending portions of the connection. A second seal typically prevents fluid (e.g. production fluids) being released from inside the connection to the threaded and axially extending portions of the connection.

Preferably the seal is formed from differential angle tapers on each spigot and socket, although any sealing means may alternatively be used.

According to a second aspect of the invention there is provided a method for connecting a first tubular to a second tubular the method comprising the steps of—

gripping a first tubular at a position spaced from its terminus;

engaging the first and second tubulars;

gripping the second tubular; and

applying torque between the tubulars.

Typically the first tubular's outer diameter increases near its terminus to form a tapered portion or ‘pin’.

Normally the first tubular's inner diameter remains constant.

Preferably the first tubular is gripped at a portion before the point that its outer diameter increases.

Normally the pin has a thread. Typically the second tubular's outer diameter increases near its terminus to provide a receiving portion or ‘box’. Normally the box has a thread which can engage the thread of the pin to form a connection between the first and second tubulars.

Typically the first connector and second connector are also sealed together by any suitable means.

The portions can simply have an axially extending component and can be deviated slightly from the axis, provided that in the assembled connector they are mutually parallel.

The length and thickness of the axially extending portions may depend on the length, size or weight of the tubulars connected. Typically the tubulars connected are 45 ft long, although they may be, for example, anywhere from 30 ft to 90 ft long. Typically the first axially extending portion on each tubular is at least 2″ long. Preferably the fist axially extending portion on each tubular are 3.5″ long. Most preferably the first axially extending portion on each tubular is 6″ long. Typically the second axially extending portion on each tubular is at least 0.5″ long. Preferably the second axially extending portion on each tubular is 1″ long. Most preferably the second axially extending portion is 2″ long.

The axially extending portions may be between 0.5 t and 3 t thick wherein ‘t’ is the thickness of the respective tubular. Preferably the axially extending portions are between 1 t and 1.5 t thick.

### BRIEF DESCRIPTION OF THE DRAWINGS

Embodiments of the invention will now be described by way of example only with reference to the accompanying drawings, wherein;

FIG. 1 is a sectional view of a standard prior art box and pin connection;

FIG. 2 is a second sectional view of a standard prior art box and pin connection;

FIG. 3 is a sectional view of a box and pin connection according to the second aspect of the invention;

FIG. 4 is a sectional view of a box and pin connection according to the first aspect of the invention;

FIG. 5 is a third sectional view of a standard prior art box and pin connection;

FIG. 6 is a second sectional view of a box and pin connection according to the first aspect of the invention;

FIG. 7 is a third sectional view of a box and pin connection according to the first aspect of the invention during assembly;

FIG. 8 is a sectional view of a thread used in a standard prior art box and pin connection; and,

FIG. 9 is a sectional view of the thread used in a box and pin connection according to the first aspect of the invention.

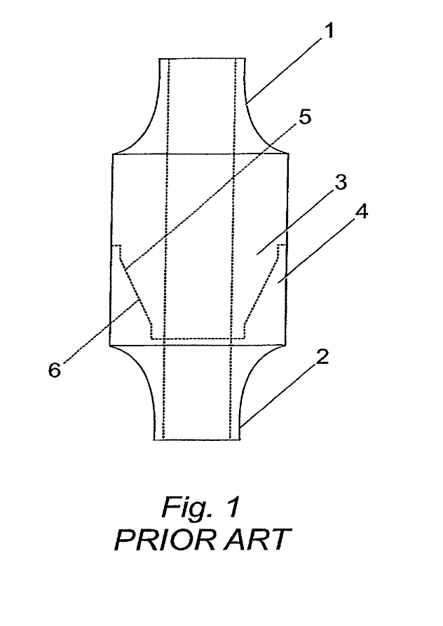

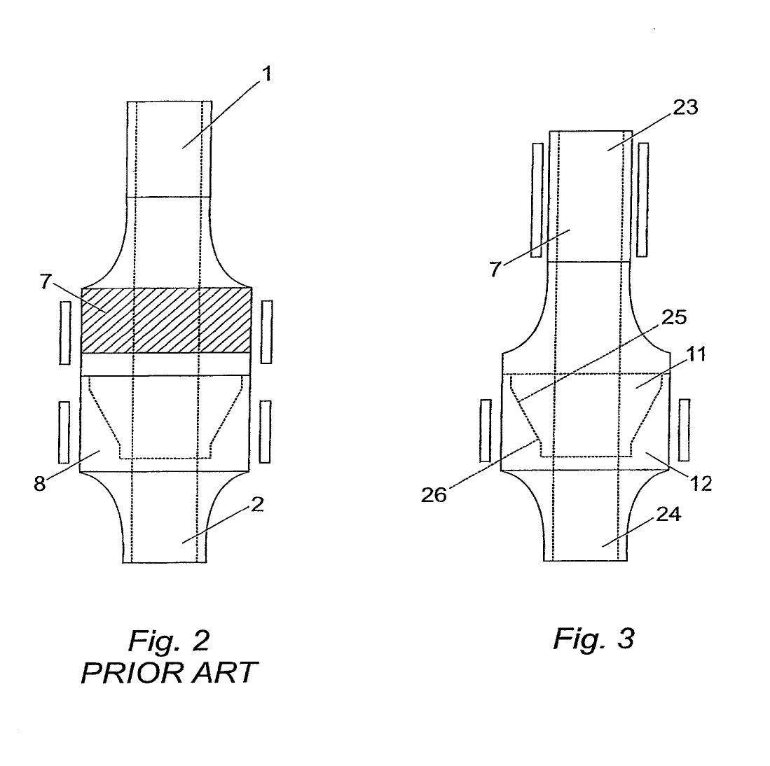

### DESCRIPTION OF THE PREFERRED EMBODIMENTS

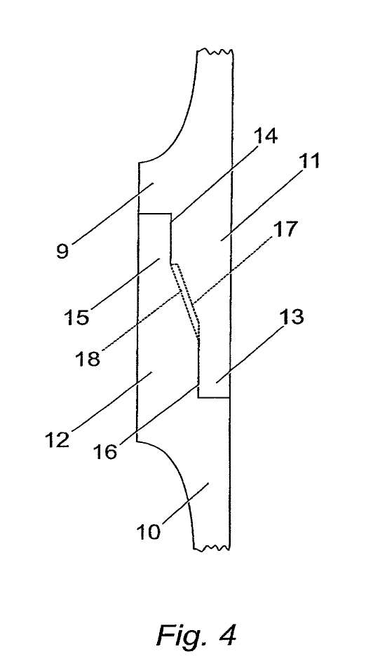

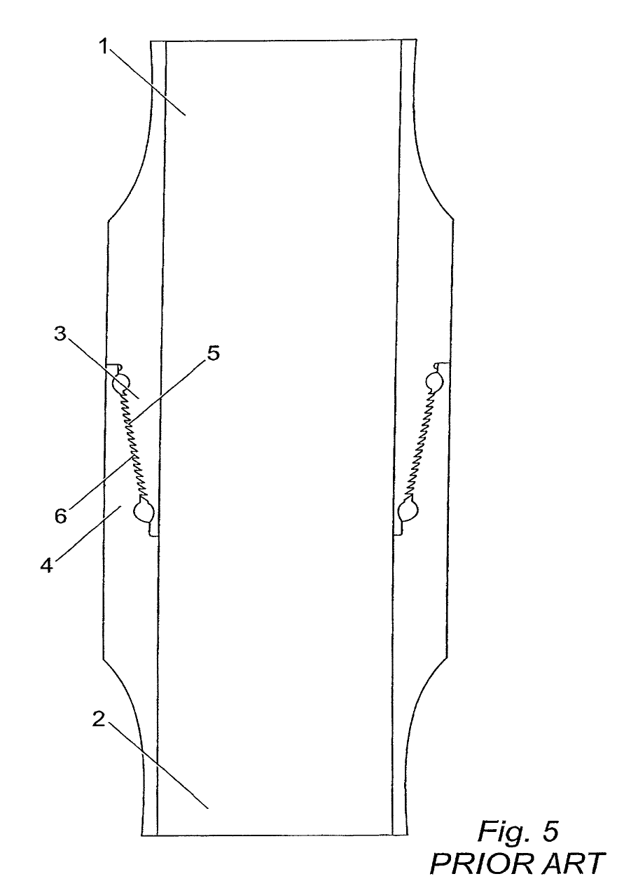

Referring to the drawings, an embodiment of a connector for pipes in accordance with a first aspect of the invention is shown in FIGS. 4, 6, 7 and 9 in which pipes or tubulars 9, 10 each have a threaded pin portion 11 and threaded box portion 12.

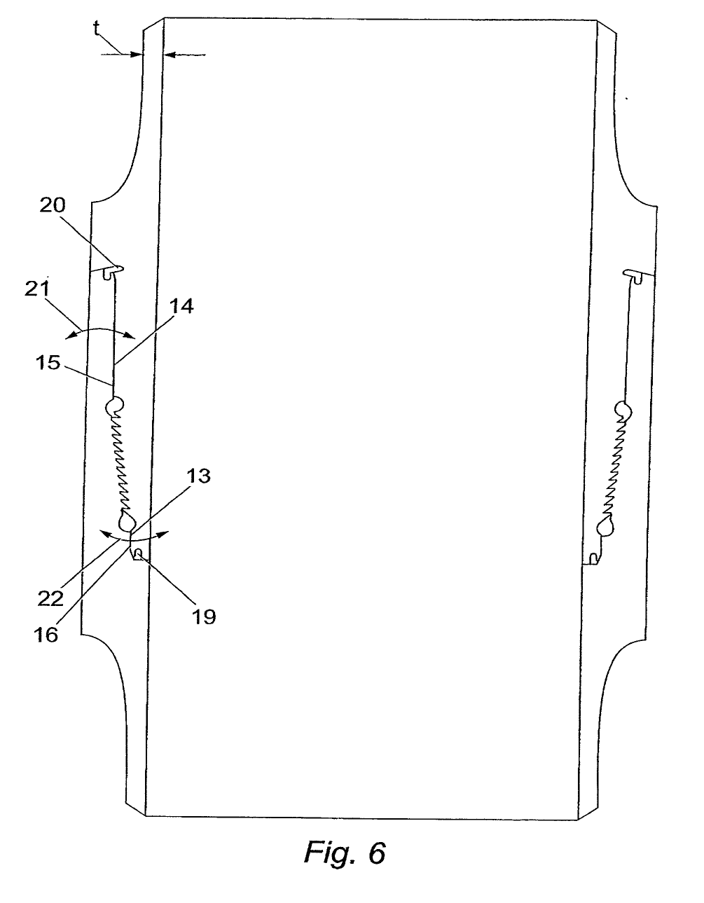

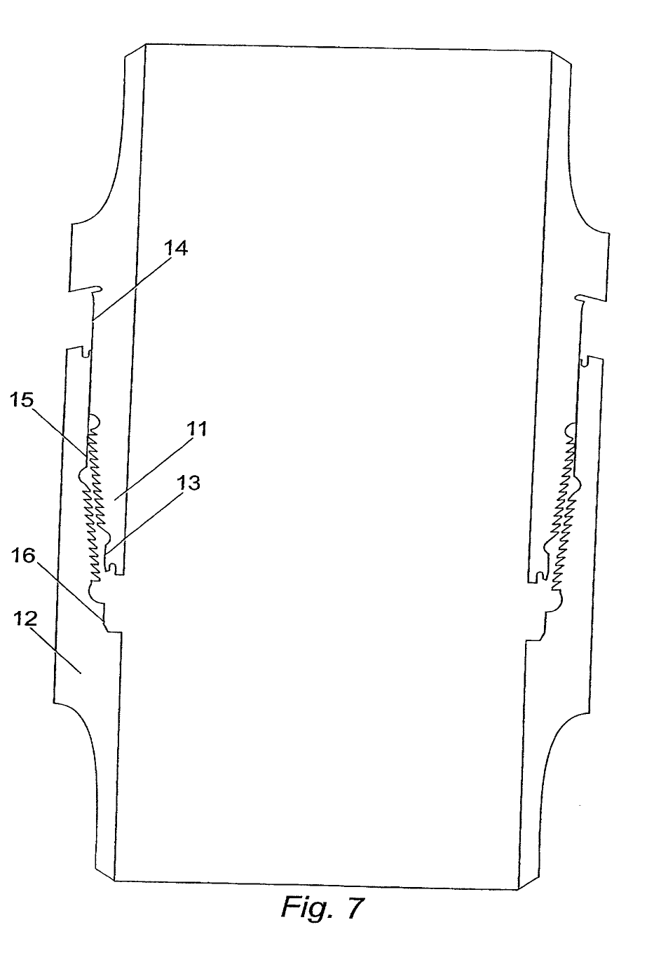

FIG. 4 shows the pin 11 and box 12 portions in their connected position. The pin portion 11 has a spigot 13 and a socket 14. The box portion 12 also has a box spigot 15 and a box socket 16. Preferably the box spigot 15 and pin socket 14 have a greater axial length than the pin spigot 13 and box socket 16 as shown in FIGS. 6 and 7. Typically the larger box spigot 15 and box socket 16 are at least 3.5″ in length and the smaller pin spigot 13 and pin socket 14 are at least 1″ in length assuming the length of the tubulars 9, 10 is 45 ft; the box and pin spigots 15, 13 and pin and box sockets 14, 16 are typically proportional with respect to the size and weight of the tubulars 9, 10.

The box and pin spigots 15,13 are arranged concentrically within the pin and box sockets 14, 16 respectively and both the spigots 15,13 and sockets 14, 16 are parallel to the axis of the tubulars 9, 10, and are thereby adapted to transfer load from one tubular 9, 10 to another. The pin portion 11 and box portion 12 have threads 17, 18 respectively for connecting the pin portion 11 to the box portion 12. Consequently, the threads 17, 18 need not be adapted to transfer radial loads and can therefore be looser than prior art threads used in risers.

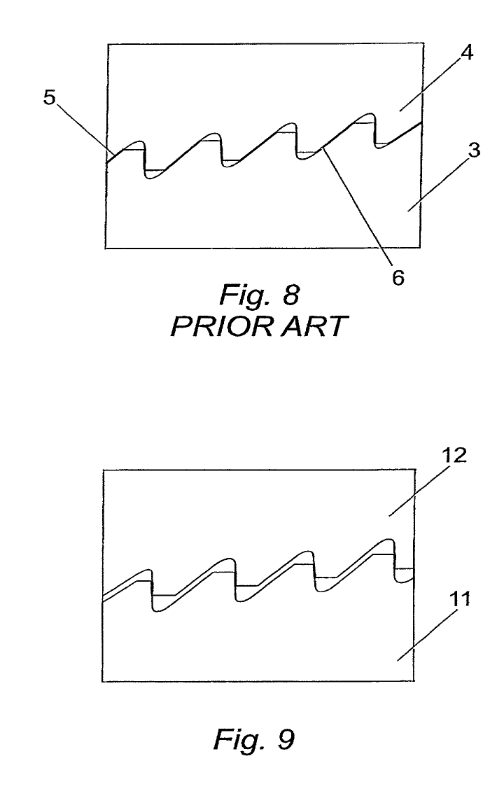

In contradistinction, prior art threads in known riser connectors are shown in FIG. 8. The pin 3 is provided with threads 5 and the box 4 is provided with threads 6. When one of the tubulars 9, 10 moves in any given direction, the radial portion of the pin threads 5 on a first side of the connector transfers the bending load to the other tubular 9, 10 via opposite radial portions on the opposite box threads 6. Such threads 5, 6 need to be carefully engineered.

Certain embodiments of the first aspect of the invention allow the use of far simpler threads which need not be designed to transfer bending loads. Such threads are shown in FIG. 9 and it can be seen that the threads are much looser compared to the prior art threads 5,6 of FIG. 8.

The looser pin and box threads 17, 18 respectively reduce manufacturing costs and ease inspection of the tubular connections. The associated savings accrue from all connections in a pipe string to provide a significant cost saving.

To form the connection between the pin portion 11 and box portion 12, each pipe is gripped by tongs and the pin portion 11 is inserted into the box portion as shown in FIG. 7. The box socket 16 and spigot 15 abut and align the pin portion 11 with the box portion 12 before their respective threads 17, 18 engage. Such alignment is a further advantage of the box socket 16 and spigot 15 as threads used in such connectors are prone to damage during this stage of the assembly of tubulars. The pipes 9, 10 are then counter-rotated and the threads 17, 18 engage to form a connection.

Once the connection is made, the box spigot 15 on the box portion 12 engages the pin socket 14 on the pin portion 11. Similarly, the pin spigot 13 on the pin portion 11 engages the box socket 16 on the box portion 12.

Seals 19, 20 are provided between the pin and box portions 11, 12 respectively. A reservoir seal 19 prevents reservoir fluids escaping from the inner bore of the tubulars into the connection. A seawater seal 20 prevents sea water from entering from outside the pipe 9, 10 string into the tubulars 9, 10. The reservoir and sea seals 19, 20 are standard differential angle tapers, with lips on the pin and box portions 11, 12 respectively engaging each other.

The box and pin spigots 15, 13 respectively and the box and pin sockets 16, 14 allow load transfer between the pipes 9, 10 without requiring the tight threads typical in the prior art.

When for example, the first pipe 9 is subject to a bending force, the pin spigot 13 and socket 14 of the pin portion 11 abut respectively against the box socket 16 and spigot 15 of the box portion 12, transferring the load to the second pipe 10. Load transfer is indicated by the arrows referenced by reference numerals 21, 22 in FIG. 6. Thus bending loads applied to a particular section of pipe are dispersed over the string as a whole by the interaction of the box and pin spigots 15, 13 respectively and the pin and box sockets 14, 16. Consequently a relatively loose thread profile—compared with prior art connectors—may be employed without detracting from the overall integrity of the seal and connection between the pipes 9, 10.

An embodiment of a connector according to a second aspect of the invention is shown in FIG. 3. As shown in FIG. 3 a first pipe 23, comprises a pin portion 11 and a pipe 24 comprises a box portion 12 at a second end of the second pipe 24. The pin portion 11 and box portion 12 have complementary threads 25, 26 respectively.

The pipes 23, 24 are connected by gripping the pipe 24 at a box portion head area 28 by tongs and the first pipe 23 at a first pipe area 29 of the first pipe 23. Therefore, the head of the pin portion 11 can be much smaller compared with prior art connectors because the pipe 23 is gripped and not the pin head. This reduces the metal required to form a connector without reducing the size of the pin and box portions 11, 12. Moreover, such pipes can be easier to manufacture and further costs can be saved.

The connection between the two pipes is thereby effected using less material and without compromising the quality of the connection or seal. The numerous connections in a pipe string leads to a significant saving in material, weight, manufacturing complexity, and the cost of the riser.

1. A connector for connecting a first tubular to a second tubular; the connector comprising a first portion on the first tubular and a second portion on the second tubular, wherein the first and second portions each have axially extending portions which in the assembled connector are mutually parallel.

2. A connector as claimed in claim 1 wherein the first and second portions have mutually engaging threaded portions.

3. A connector as claimed in claim 2 wherein the axially extending portions are unthreaded.

4. A connector as claimed in claim 3 wherein the axially extending portions are load-bearing and allow the transfer of loads between the tubulars.

5. A connector as claimed in claim 4 wherein two axially extending portions are provided on each tubular.

6. A connector as claimed in claim 5 wherein the first axially extending portion on each tubular is greater in length than the second axially extending portion on each tubular.

7. A connector as claimed in claim 6 wherein the axially extending portions on each tubular are provided above and below the threaded portion.

8. A connector as claimed in claim 7 wherein a spigot and a socket comprise the axially extending portions on each tubular.

9. A connector as claimed in claim 8 wherein the spigot is provided between the tubular's threaded face and terminus.

10. A connector as claimed in claim 9 wherein the spigot on the first tubular engages the socket on the second tubular.

11. A connector as claimed in claim 10 wherein the spigot on the second tubular engages the socket on the second tubular.

12. A connector as claimed in claim 11 wherein the first tubular comprises a pin connector.

13. A connector as claimed in claim 12 wherein the second tubular comprises a box connector.

14. A connector as claimed in claim 13 wherein the socket of the first tubular and spigot on the second tubular are greater in length than the socket of the second tubular and spigot of the first tubular.

15. A connector as claimed in claim 14 wherein the axially extending portions are parallel to the axis of the tubulars.

16. A connector as claimed in claim 15 wherein the first and second tubulars have a tapered profile.

17. A connector as claimed in claim 16 wherein the tapered portions of the first and second tubulars are the threaded portions of the first and second tubulars and have co-operating tapers to facilitate mating of the two portions.

18. A method for connecting a first tubular to a second tubular the method comprising the steps of—
gripping a first tubular at a position spaced from its terminus;
engaging the first and second tubulars;
gripping the second tubular; and
applying torque between the tubulars.
